(19) United States
(12) Patent Application Publication
(10) Pub. No.: US 2007/0042233 A1
(43) Pub. Date: Feb. 22, 2007

(54) Systems and methods for initiating auxiliary fuel cell system operation

(76) Inventors: Scott W. Lyman, Bend, OR (US); Douglas B. Suckow, Bend, OR (US); Aaron Vanderzanden, Bend, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/404,721

(22) Filed: Apr. 14, 2006

Related U.S. Application Data
(60) Provisional application No. 60/709,612, filed on Aug. 19, 2005.

(51) Int. Cl. H01M 16/00; H01M 8/04; H02J 7/00

(52) U.S. Cl. 429/9; 429/23; 320/101; 429/13

(57) ABSTRACT

Fuel cell systems that provide backup, or auxiliary, power to one or more energy-consuming devices normally powered by a primary power source (PPS). Operating methods and controllers for auxiliary fuel cell systems and/or for power systems that include a PPS and an auxiliary power source in the form of an auxiliary fuel cell system (AFCS) are also disclosed. In some embodiments, the fuel cell system includes, or is in communication with, a controller that selectively initiates the production of an electric current by the AFCS responsive to a triggering event. An illustrative triggering event includes a predetermined voltage drop across a diode or similar current-regulating, or flow-regulating, device that is electrically between the AFCS and the energy-consuming device(s) and/or the PPS. Another illustrative triggering event includes the voltage (or state of charge or readiness to satisfy an applied load) of a battery or other energy-storage device associated with the AFCS.

### RELATED APPLICATION

The present application claims priority to similarly entitled U.S. Provisional Patent Application Ser. No. 60/709,612, which was filed on Aug. 19, 2005, and the complete disclosure of which is hereby incorporated by reference.

### FIELD OF THE DISCLOSURE

The present disclosure is directed to fuel cell systems, and more particularly to fuel cell systems that are adapted to provide backup, or auxiliary, power to an energy-consuming assembly that is adapted to be principally powered by a primary power source.

### BACKGROUND OF THE DISCLOSURE

Fuel cell stacks are electrochemical devices that produce water and an electric potential from a fuel, which typically is a proton source, and an oxidant. Many conventional fuel cell stacks utilize hydrogen gas as the proton source and oxygen, air, or oxygen-enriched air as the oxidant. Fuel cell stacks typically include many fuels cells that are fluidly and electrically coupled together between common end plates. Each fuel cell includes anode and cathode regions that are separated by an electrolytic membrane. Hydrogen gas is delivered to the anode region, and oxygen gas is delivered to the cathode region. Protons from the hydrogen gas are drawn through the electrolytic membrane to the anode region, where water is formed. Conventionally, the anode and cathode regions are periodically purged to remove water and accumulated gases in the regions. While protons may pass through the membranes, electrons cannot. Instead, the electrons that are liberated by the passing of the protons through the membranes travel through an external circuit to form an electric current.

Fuel cell systems may be designed to be the primary or backup power source for an energy consuming assembly that includes one or more energy-consuming devices. When implemented as a backup, or auxiliary, power source for an energy-consuming assembly, the fuel cell system is utilized during times when the primary power source is unable or unavailable to satisfy the energy demand, or applied load, of the energy-consuming assembly. In some applications, it is desirable for the auxiliary fuel cell systems to be adapted to satisfy this applied load without a disruption, or interruption, in the operation of the energy-consuming assembly. For example, auxiliary fuel cell systems may be configured to provide uninterruptible power supply (UPS) systems for electronics or other devices where it is important to maintain a continuous power supply. In other applications, a brief period of power outage is acceptable so long as the auxiliary fuel cell system is able to provide the required power within a selected time period after the primary power source is unable to satisfy the applied load.

Accordingly, a consideration when designing auxiliary fuel cell systems is the time required for the fuel cell system to be able to provide power to satisfy an applied load. A related consideration is the cost, equipment, and size of such an auxiliary fuel cell system.

### SUMMARY OF THE DISCLOSURE

The present disclosure is directed to fuel cell systems that are adapted to provide backup, or auxiliary, power to one or more energy-consuming devices that are normally adapted to be powered by a primary power source. The disclosure is further directed to operating methods and controllers for auxiliary fuel cell systems and/or for power systems that include a primary power source and an auxiliary power source in the form of an auxiliary fuel cell system. In some embodiments, the fuel cell system includes, or is in communication with, a controller that is adapted to selectively initiate the production of an electric current by the auxiliary fuel cell system responsive to at least one triggering event. An illustrative triggering event includes a predetermined voltage drop across a diode or similar current-regulating, or flow-regulating device that is electrically positioned between the auxiliary fuel cell system and the energy-consuming device(s) and/or the primary power source. Another illustrative triggering event includes the voltage (or state of charge or readiness to satisfy an applied load) of a battery or other energy-storage device associated with the auxiliary fuel cell system.

### BRIEF DESCRIPTION OF THE DRAWINGS

FIG. 1 is a schematic view of an energy-producing system according to the present disclosure, with the energy-producing system being adapted to provide a power output to satisfy the applied loads from an energy-consuming assembly, and with the energy-producing system including a primary power source and an auxiliary power source, which includes at least one fuel cell stack.

FIG. 2 is a schematic view of another energy-producing system in electrical communication with an energy-consuming assembly according to the present disclosure.

FIG. 3 is a schematic view of another energy-producing system in electrical communication with an energy-consuming assembly according to the present disclosure.

FIG. 4 is a schematic view of an illustrative auxiliary power system in the form of an auxiliary fuel cell system.

FIG. 5 is a schematic view of another illustrative auxiliary power system in the form of an auxiliary fuel cell system.

FIG. 6 is a schematic view of another illustrative auxiliary power system in the form of an auxiliary fuel cell system.

FIG. 7 is a schematic view of illustrative aspects of a fuel cell system.

FIG. 8 is a flowchart illustrating examples of methods, or procedures, for selectively initiating or deferring startup of current production by a fuel cell stack in an auxiliary fuel cell system according to the present disclosure.

FIG. 9 is a schematic view of another illustrative auxiliary fuel cell system that may be used with power systems according to the present disclosure.

FIG. 10 is a schematic view of an illustrative hydrogen generation assembly that may be used with auxiliary fuel cell systems according to the present disclosure.

FIG. 11 is a schematic view of another illustrative hydrogen generation assembly that may be used with auxiliary fuel cell systems according to the present disclosure.

FIG. 12 is a schematic view of another illustrative hydrogen generation assembly that may be used with auxiliary fuel cell systems according to the present disclosure.

### DETAILED DESCRIPTION AND BEST MODE OF THE DISCLOSURE

In FIG. 1, an energy-consuming assembly is shown and generally indicated at 51. Energy-consuming assembly 51 includes at least one energy-consuming device 52 and is adapted to be powered by at least one of a primary power source (PPS) 132 and an auxiliary power source (APS) 21. The primary power source and auxiliary power source may be referred to as a power, or energy-producing, system 130 that includes primary and backup, or auxiliary, power sources. Expressed in slightly different terms, energy-consuming assembly 51 includes at least one energy-consuming device that is in electrical communication with the energy-producing system.

The energy-consuming assembly is adapted to apply a load, which typically includes at least an electrical load, to energy-producing system 130, with the primary power source being adapted to satisfy that load (i.e., by providing a sufficient power output to the energy-consuming assembly), and with the auxiliary power source being adapted to provide a power output to at least partially, if not completely, satisfy the applied load when the primary power source is unable or otherwise unavailable to do so. These power outputs may additionally or alternatively be referred to herein as electrical outputs. The power and/or electrical outputs may be described as having a current and a voltage. It is within the scope of the present disclosure that the APS is adapted to immediately satisfy this applied load upon the PPS being unable to do so. In other words, it is within the scope of the present disclosure that the APS is adapted to provide energy-consuming assembly 51 with an uninterruptible power supply, or an uninterrupted supply of power. By this it is meant that the APS may be configured to provide a power output that satisfies the applied load from energy-consuming assembly 51 in situations where the PPS is not able or available to satisfy this load, with the APS being adapted to provide this power output sufficiently fast that the power supply to the energy-consuming assembly is not, or not noticeably, interrupted. By this it is meant that the power output may be provided sufficiently fast that the operation of the energy-consuming assembly is not stopped or otherwise negatively impacted.

It is within the scope of the present disclosure that this load, which may be referred to as an applied load, may additionally or alternatively include a thermal load. The energy-consuming assembly is in electrical communication with the primary and auxiliary power sources via any suitable power conduit, such as schematically represented at 75 in FIG. 1. The PPS and APS may be described as having electrical buses in communication with each other and the energy-consuming assembly.

Illustrative, non-exclusive examples of energy-consuming devices 52 that may form all or a portion of the energy-consuming assembly include motor vehicles, recreational vehicles, boats and other sea craft, and any combination of one or more households, residences, commercial offices or buildings, neighborhoods, tools, lights and lighting assemblies, appliances, computers, telecommunications equipment, industrial equipment, signaling and communications equipment, radios, electrically powered components of (or on) boats, recreational vehicles or other vehicles, battery chargers and even the balance-of-plant electrical requirements for the energy-producing system 130. In the context of the present disclosure, the auxiliary power system includes at least one fuel cell stack and at least one battery or other suitable energy-storage device 78, the energy-producing system is adapted to provide DC power to the energy-consuming assembly, and the energy-producing system includes a controller that is adapted to regulate at least the operating state of the fuel cell system responsive at least in part to one or both of the voltage of the energy-storage device and the relative flow of current from the auxiliary power source, such as through the diode.

Energy-consuming assembly 51 is adapted to be primarily, or principally, powered by a power source, which is generally indicated at 132 in FIG. 1. Because power source 132 is adapted to be the principal power source for the energy-consuming assembly, power source 132 may be referred to as a primary power source, or PPS, for assembly 51. Primary power source 132 may be any suitable source of a suitable power output 81 for satisfying the applied load from the energy-consuming assembly. For example, PPS 132 may include an electrical utility grid, a fuel cell system, a solar power system, a wind power system, a nuclear power system, a hydroelectric power system, etc. PPS 132 will typically be configured to provide a power output 81.

As discussed, auxiliary power source (APS) 21 includes at least one fuel cell stack 24 and therefore may be described as including or taking the form of a fuel cell system 22 that is adapted to produce a power output 79 that may be utilized to satisfy at least a portion, if not all, of the applied load from the energy-consuming assembly. Auxiliary power source 21 also may be referred to as an auxiliary fuel cell system or a fuel cell system that is adapted to provide backup power to the energy-consuming assembly. Additional illustrative, non-exclusive examples of auxiliary fuel cell systems, and components and configurations therefor, are disclosed in U.S. patent application Ser. No. 10/458,140, the complete disclosure of which is hereby incorporated by reference.

As discussed, the primary and auxiliary power sources are adapted to provide DC power outputs, or power supplies, 81 and 79, respectively. It is within the scope of the present disclosure that the power outputs may be selectively produced from AC power supplies, or sources, which are converted to a DC output by a suitable AC/DC converter or other suitable power management module. Similarly, it is within the scope of the present disclosure that the power outputs may be converted, via a suitable DC/AC converter or other suitable power management module, to an AC power output. However, in at least the portion of the energy-producing system in which the subsequently described controller selectively regulates the operation of the auxiliary fuel cell system, power outputs 79 and 81 are DC power outputs. As an illustrative, non-exclusive example, the PPS may be configured to provide a nominal DC power output, such as 12 volts, 18 volts, 24 volts, 36 volts, 48 volts, etc. It should be understood that the actual voltage of such power outputs will tend to be greater than the nominal voltage during proper operation of the PPS. For example, a system adapted to provide a nominal 12-volt power output will typically be configured to provide a power output with a (float) voltage of at least 13 volts, such as 13.8 volts. Accordingly, a nominal 48-volt system will typically be configured to provide a power output of approximately 54 volts, or more. This actual voltage may tend to vary with such factors as temperature. The auxiliary power source will typically be adapted to provide a power output having a lower voltage than the power output that the PPS is configured to provide. For example, the APS may (but is not required in all embodiments) be adapted to provide a power output 79 having a voltage that is less than the (bus) voltage of the power output that the PPS is designed to provide. For example, the APS may be configured to produce a power output that is at least 1 volt, and optionally 1-2 volts, or even more than 2 volts, lower than the power output 81 that the PPS is configured to provide.

Also shown in FIG. 1 is a diode 140 and a controller 142. Diode 140 is electrically positioned between energy-consuming assembly 51 and the power output 79 from the auxiliary fuel cell system. Diode 140 schematically represents any suitable number and/or type of diode or other similar structure that is adapted to be forward-biased to permit current flow from the APS and/or from the PPS, to the energy-consuming assembly, while restricting current flow from the PPS to the APS. Controller 142 schematically represents any suitable structure for selectively implementing the control process described herein for determining whether and when to initiate (and/or defer) the production of an electric current by the fuel cell stack 24 of the auxiliary fuel cell system. Accordingly, controller 142 may include a processor, software executing on a processor, one or more digital and/or analog circuits, etc. Controller 142 may be a discrete component that is entirely adapted to provide the selective initiation of the fuel cell stack producing a power output, and/or may be implemented with other controllers and/or control components that are adapted to regulate other components and/or operations of at least the APS.

As indicated in FIG. 1, controller 142 is in communication with at least diode 140 and the APS, such as the battery or other energy-storage device 78 thereof. This communication may be implemented via any suitable wired or wireless communication linkages 144 and may include one- or two-way communication. As discussed in more detail herein, controller 142 is adapted to detect or otherwise receive inputs corresponding to the voltage drop, if any, across the diode and the voltage of the auxiliary fuel cell system's power output 79. As an illustrative, non-exclusive example, this voltage may be measured by measuring or otherwise detecting the voltage of the battery or other energy-storage device 78 of the auxiliary fuel cell system. Controller 142 is further adapted to selectively initiate, such as through the generation of suitable control signals, the production of an electric current by the fuel cell stack 24 of the auxiliary fuel cell system. As discussed in more detail herein, controller 142 and/or APS 21 is preferably configured not to always respond to a reduction in the capacity of the primary power source to satisfy the applied load by initiating the production of an electric current by the auxiliary fuel cell system. Instead, controller 142 is preferably adapted to determine whether it is necessary to immediately startup the fuel cell stack of the APS or whether it will be sufficient to permit the battery or other energy-storage device of the APS to satisfy the applied load.

System 130, and its component APS and PPS systems 21 and 132, may include additional components that are not specifically illustrated in the schematic figures, such as air delivery systems, heat exchangers, sensors, controllers, flow-regulating devices, fuel and/or feedstock delivery assemblies, heating assemblies, cooling assemblies, power management components, and the like.

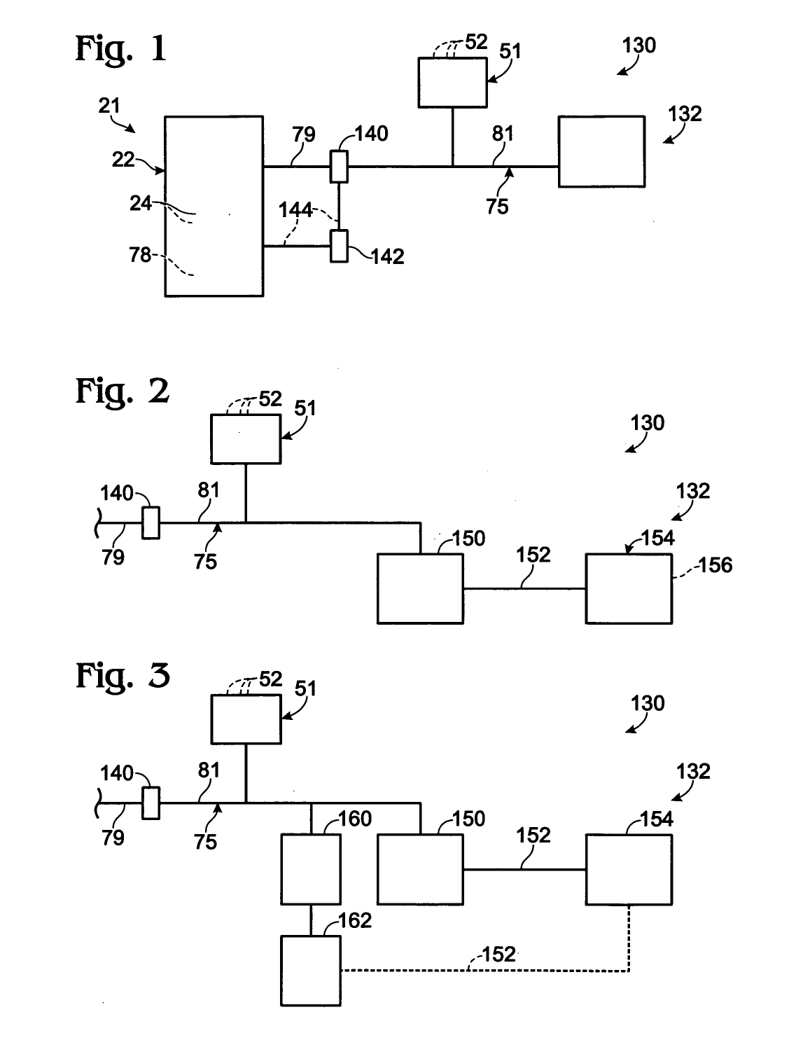

In FIG. 2, a schematic, non-exclusive example of suitable components for primary power source 132 are shown. As shown, the PPS includes a rectifier 150 that is adapted to receive a power output, or signal, 152 from a power supply 154, such as an electric utility grid 156. It is within the scope of the present disclosure that power supply 154 may take other suitable forms, such as a turbine, generator, fuel cell stack or fuel cell system (other than the components of APS 21), etc. Similarly, it is within the scope of the present disclosure that power supply 154 may be described as part of PPS 132 and/or that the PPS is described as being in communication with power supply 154 and adapted to receive a suitable power signal therefrom. The rectifier is adapted to convert this AC signal to a DC signal that forms power output 81 of the PPS. Rectifier 150 and/or PPS 132 may include or be in communication with any suitable power management components, such as buck or boost converters, power filters, and the like.

Another illustrative, non-exclusive example of a suitable configuration for PPS 132 is shown in FIG. 3. As shown, the PPS further includes a battery 160 and an optional charger 162 that is adapted to selectively charge the battery. As indicated in dashed lines in FIG. 3, the charger may be adapted to receive a power signal from power supply 154. Battery 160 may include any suitable type and number of cells and may be referred to as a battery assembly that includes at least one battery.

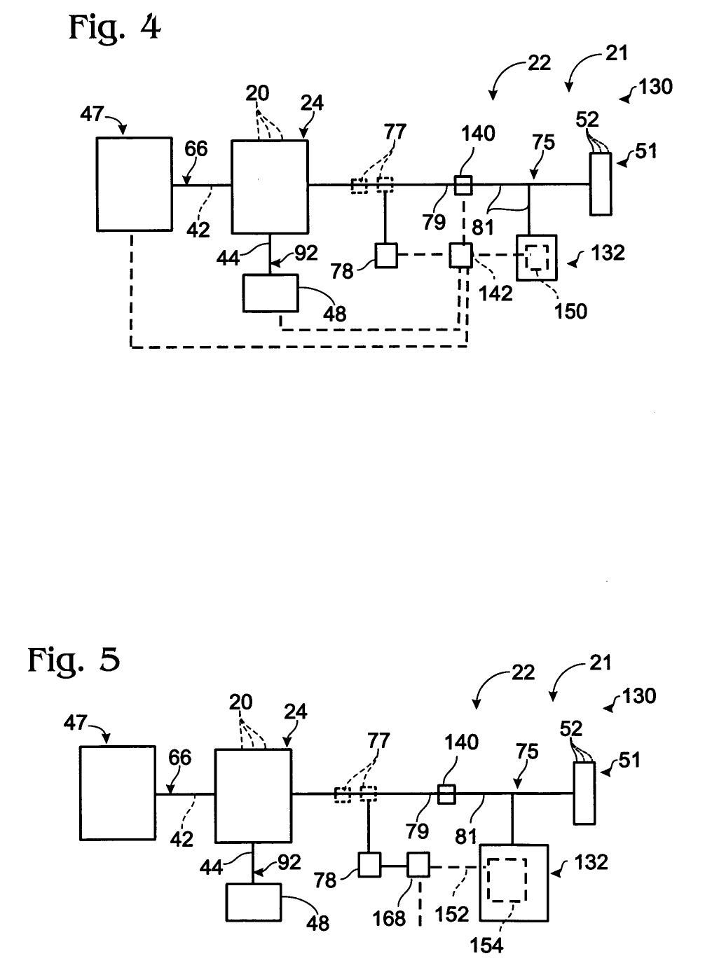

An illustrative, non-exclusive example of a suitable configuration for auxiliary fuel cell system 22 is schematically illustrated in FIG. 4. As discussed in more detail herein, system 22 includes at least one fuel cell stack 24. Fuel cell stack 24 is adapted to produce an electric current from fuel 42 and oxidant 44 that are delivered to the stack. Fuel 42 is any suitable reactant, or feedstock, for producing an electric current in a fuel cell stack when the fuel and an oxidant are delivered to the anode and cathode regions, respectively, of the fuel cells in the stack. Fuel 42 may, but is not required to be, a proton source. In the following discussion, fuel 42 will be described as being hydrogen gas, and oxidant 44 will be described as being air, but it is within the scope of the present disclosure that other suitable fuels and/or oxidants may be used to produce a power output 79 in fuel cell stack 24. For example, other suitable oxidants include oxygen-enriched air streams, and streams of pure or substantially pure oxygen gas. Illustrative examples of other suitable fuels include methanol, methane, and carbon monoxide.

As schematically illustrated in FIG. 4, system 22 includes (or is in communication with) a source, or supply, 47 of hydrogen gas (or other fuel) and an air (or other oxidant) source, or supply, 48. The sources are adapted to deliver hydrogen and air streams 66 and 92 to the fuel cell stack 24. Hydrogen 42 and oxygen 44 may be delivered to the fuel cell stack via any suitable mechanism from sources 47 and 48. Stack 24 produces from these streams a power output, which is schematically represented at 79. As indicated in dashed lines at 77 in FIG. 4, the auxiliary fuel cell system may, but is not required to, include at least one power management module 77. Power management module 77 includes any suitable structure for conditioning or otherwise regulating the electricity produced by the auxiliary fuel cell system, such as for delivery to energy-consuming assembly 51. Module 77 may include such illustrative structure as buck or boost (DC/DC) converters, inverters, power filters, and the like.

Auxiliary fuel cell system 22 preferably includes at least one battery or other suitable energy-storage device 78. Device 78 is adapted to store at least a portion of the electrical output, or power, 79 from the fuel cell stack 24. Illustrative, non-exclusive examples of other suitable energy-storage devices that may be used in place of or in combination with one or more batteries include capacitors and ultracapacitors. Energy-storage device 78 may additionally or alternatively be used to power the energy-producing system 22 during startup of the system. The following discussion will describe the PPS and APS as including energy-storage devices in the form of batteries, although as discussed above, this is not required to all embodiments. As shown in FIG. 4, controller 142 is in communication with at least rectifier 150 and battery 78 to selectively receive inputs corresponding to the voltage drop across the rectifier and the voltage of the battery. As also shown in FIG. 4, the controller is further illustrated to be in communication with at least the hydrogen and air sources 47 and 48 (or other sources of fuel and/or oxidant for the fuel cell stack), such as to send input, or control, signals thereto. For example, upon determination that the fuel cell stack needs to be started up (i.e., that initialization of the production of an electric current by the fuel cell stack needs to occur), the controller may send command signals to one or both of sources 47 and 48 (and/or associated flow-regulating devices) to initiate the flow of hydrogen and oxygen to the fuel cell stack.

Battery 78 of the auxiliary fuel cell system may be sized to have sufficient capacity to satisfy the entirety of the expected applied load from energy-consuming assembly 51 for at least a sufficient period of time for the auxiliary fuel cell system to transition from a shutdown or other operating state in which the fuel cell stack is not producing an electric current to a power-producing operating state, in which the fuel cell stack is producing an electric current from flows of fuel and oxidant (such as hydrogen and air/oxygen) that are delivered thereto. In many embodiments, it may be desirable for battery 78 to have at least a predetermined amount of excess capacity, such as 10%, 20%, 50%, or more, than would be required for the fully charged battery to be able to satisfy the applied load only until operation of the fuel cell stack was initiated.

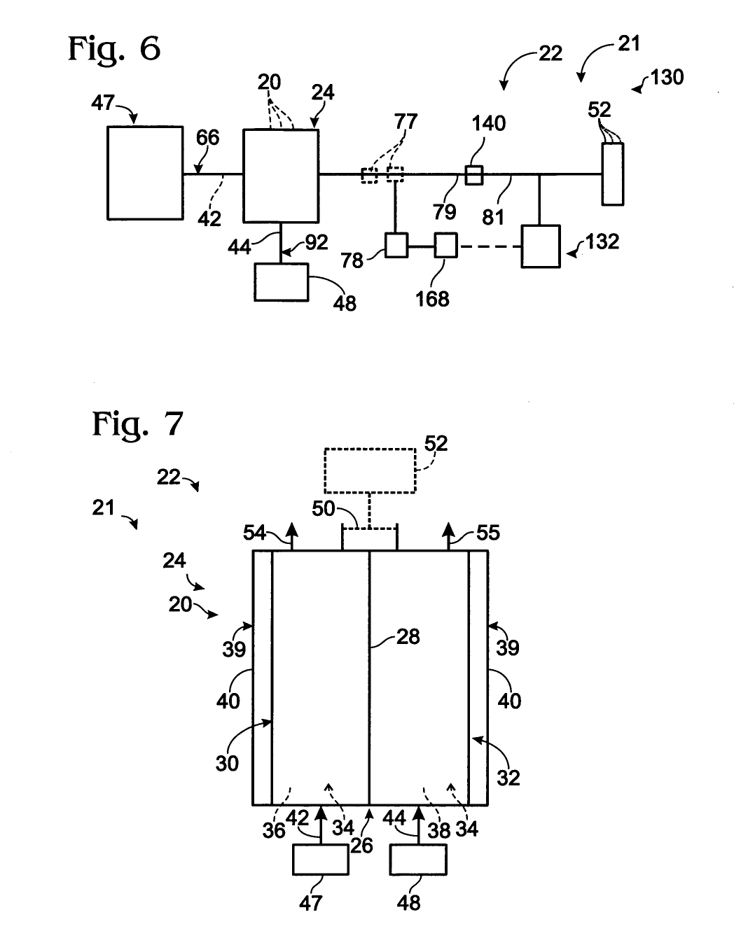

FIG. 5 illustrates that APS 21 may include a charger 168 that is adapted to charge battery (or other energy storage device) 78 and that the charger may optionally be adapted to receive a power signal/supply 152 from the same source 154 as a charger for a battery (when present) of the PPS. As discussed, source 154 may, but is not required to, include an electrical utility grid. FIG. 6 illustrates that the charger may be adapted to be powered by the primary power source.

Fuel cell stack 24 may utilize any suitable type of fuel cell. Illustrative examples of suitable fuel cells include proton exchange membrane (PEM) fuel cells and alkaline fuel cells. Stack 24 (and system 22) may also be adapted to utilize such fuel cells as solid oxide fuel cells, phosphoric acid fuel cells, and molten carbonate fuel cells. For the purpose of illustration, an exemplary fuel cell 20 in the form of a PEM fuel cell is schematically illustrated in FIG. 7.

Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a support 39, such as a supporting plate 40. Support 39 may form a portion of the bipolar plate assemblies that are discussed in more detail herein. The supporting plates 40 of fuel cells 20 carry the relative voltage potentials produced by the fuel cells.

In operation, hydrogen gas 42 from supply 47 is delivered to the anode region, and air 44 from supply 48 is delivered to the cathode region. Hydrogen 42 and oxygen 44 may be delivered to the respective regions of the fuel cell via any suitable mechanism from respective sources 47 and 48. Examples of suitable sources 47 for hydrogen 42 include a pressurized tank, metal hydride bed or other suitable hydrogen storage device, a chemical hydride (such as a solution of sodium borohydride), and/or a fuel processor or other hydrogen generation assembly that produces a stream containing pure or at least substantially pure hydrogen gas from at least one feedstock. Examples of suitable sources 48 of oxygen 44 include a pressurized tank of oxygen, oxygen-enriched air, or air, or a fan, compressor, blower or other device for directing air to the cathode regions of the fuel cells in the stack.

Hydrogen and oxygen typically combine with one another via an oxidation-reduction reaction. Although membrane 28 restricts the passage of a hydrogen molecule, it will permit a hydrogen ion (proton) to pass through it, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 7. In cathode region 32, electrons from the external circuit and protons from the membrane combine with oxygen to produce water and heat. Thermal management systems may be adapted to selectively regulate this heat to maintain the fuel cell within a predetermined, or selected, operating temperature range, such as below a maximum threshold temperature, and/or above a minimum threshold temperature.

Also shown in FIG. 7 are an anode purge, or exhaust, stream 54, which may contain hydrogen gas, and a cathode air exhaust stream 55, which is typically at least partially, if not substantially, depleted of oxygen. Fuel cell stack 24 may include a common hydrogen (or other reactant) feed, air intake, and stack purge and exhaust streams, and accordingly will include suitable fluid conduits to deliver the associated streams to, and collect the streams from, the individual fuel cells. Similarly, any suitable mechanism may be used for selectively purging the regions.

In practice, fuel cell stack 24 will include a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load, such as from at least one of an energy-consuming device 52 and the energy-producing system 22.

Controller 142 is adapted to determine whether one or more triggering conditions, or events, are present that justify initiating the startup of the auxiliary fuel cell system. By this it is meant that the controller determines whether it is necessary to send control signals or other commands (such as to at least one or more of the sources of hydrogen and oxygen 47 and 48) to begin generating an electric current with the fuel cell stack and to thereafter ramp the fuel cell stack toward or up to its full power producing state. However, controller 142 is not required, in all situations, to begin this startup of the fuel cell system. In some applications, it may be configured to merely monitor one or more selected variables responsive to the detection of an operating parameter or triggering condition that indicates a potential future, but not present, need to initialize startup of the fuel cell system.

Although other parameters may be utilized without departing from the scope of the present disclosure, controller 142 may be adapted to monitor the voltage drop across diode 140, which is referred to herein as vDIODE, and the voltage of the auxiliary fuel cell system's battery 78, which is referred to herein as vBATT. Because auxiliary fuel cell system 22 includes a battery or other energy storage device, it should have a “buffer” of stored energy, with this buffer being able to be used to selectively satisfy at least a portion of the applied load without requiring that the auxiliary fuel cell stack be transitioned from its shutdown operating state to an operating state where it is producing power output 79. By “buffer” it is meant that the auxiliary fuel cell system may be able to satisfy an applied load using the battery or other energy storage device for at least a period of time, such as before and/or while the fuel cell stack is transitioned to an operating state. Additionally, in embodiments of the present disclosure where the battery (or other energy storage device) is adapted to be recharged by a power source other than the auxiliary fuel cell stack itself, the buffer provided by this storage device may exceed the single-charge capacity of the battery. For example, battery 78 may be electrically connected to a charger, which is powered by the same or a different power source as the battery associated with the primary power source. When the battery is configured to be recharged while it is still electrically connected to satisfy at least a portion of the applied load, the battery may be used to satisfy this load for a sufficient period of time to correct whatever event indicated a potential need to startup power production by the auxiliary fuel cell stack. In some situations, or responsive to selected triggering events, it will be necessary to startup the production of power output 79 by the auxiliary fuel cell system. Controller 142 may be configured to initiate this startup immediately upon detection of the event and/or after a predetermined period of monitoring the event or parameter, such as to see if it persists or becomes more significant, such as deviating to a greater extent from a preferred, or normal, value.

Illustrative examples of situations, or triggering events, in which the PPS may be unable to satisfy the applied load from the energy-consuming assembly include a shutdown or other failure within the electrical grid or other power source 154, a break or other disconnect within the power linkages associated with the PPS, failure of the rectifier and/or battery of the PPS, etc. It is also within the scope of the present disclosure that the controller may be adapted to initiate startup of the production of power output 79 by the auxiliary fuel cell stack responsive to one or more triggering events, or detected parameters, associated with the APS. Illustrative, non-exclusive examples of these potential events include the charge of battery 78 falling below a predetermined minimum threshold, the charger for the battery failing, the power source to recharge the battery failing, a break in the electrical conduits between the battery and the applied load, an applied load that exceeds the capacity of the APS's battery (and/or battery and charger), etc.

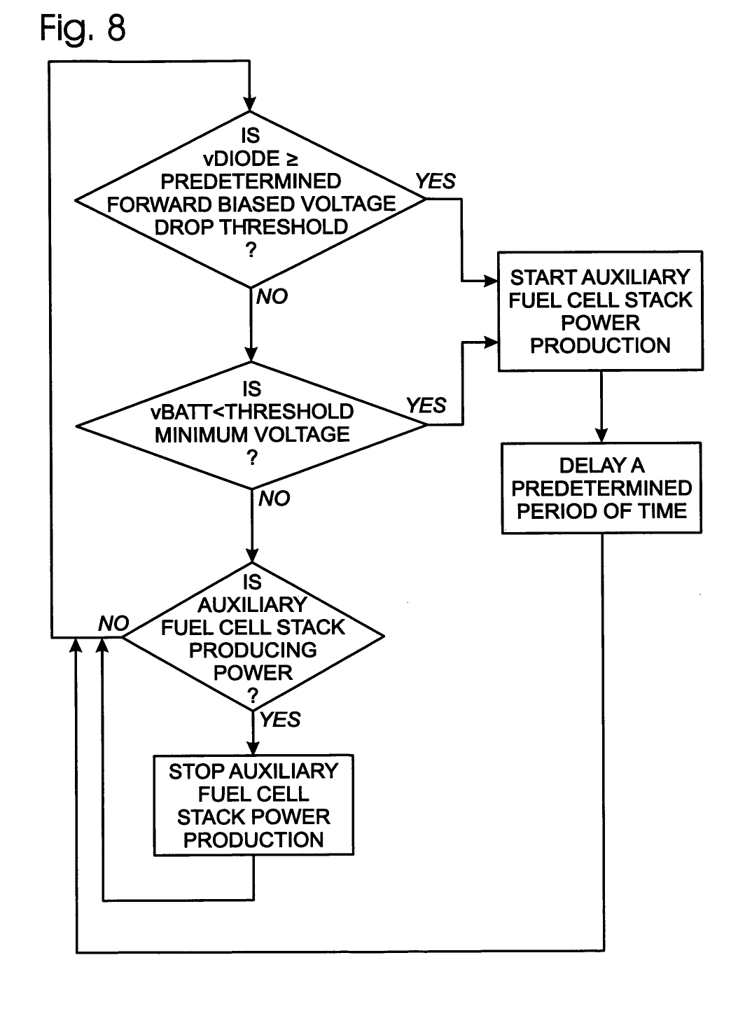

Controller 142 may be adapted to determine if one or more of these (or other) triggering events has occurred by monitoring the vDIODE to determine if any current is flowing from the APS through the diode. Should this occur and be greater than the predetermined forward-biased voltage drop across the diode, then the controller may be programmed or otherwise configured to initiate startup of the production of power output 79 by the auxiliary fuel cell stack. However, if vDIODE is less than or equal to (≦) 0, which indicates that no current is flowing through the diode from the APS, no corrective action may be required by the controller. FIG. 8 provides an illustrative, non-exclusive flow chart illustrating examples of determinations and responses that a controller may implement (or be programmed or otherwise configured to implement). FIG. 8 also includes an optional delay step, with the illustrated delay period being selected based upon a variety of factors, including the specific construction of the APS, PPS, and/or controller, as well as design preferences, etc.

Diodes have a fully saturated forward-biased voltage drop. This value will tend to vary depending upon the semiconductor material(s) from which the diode is formed. For example, for silicon diodes the conducting forward-biased voltage drop is approximately 0.7 volts, for germanium diodes the conducting forward-biased voltage drop is approximately 0.3 volts, and for selenium diodes the conducting forward-biased voltage drop is approximately 1 volt. When vDIODE is greater than 0, this indicates that the APS is providing some power to the energy-consuming assembly and/or PPS. However, it is within the scope of the present disclosure that the controller will not automatically initiate startup of the production of power output 79 by the auxiliary fuel cell stack merely because this forward-biased voltage drop has been detected. For example, controller 142 may be adapted to only initiate startup of the fuel cell stack if the forward-biased voltage drop is at least a selected percentage of the fully saturated forward-biased voltage drop. Illustrative percentages include 30%, 40%, 50%, 60%, 75%, etc. Additionally or alternatively, the controller may be adapted to only initiate startup of the auxiliary fuel cell stack if vBATT is also at or below a threshold minimum voltage. Should this not occur or should vDIODE be less than this selected percentage of the fully saturated forward-biased voltage drop, then the controller may be configured to take no control/corrective action and/or to (continue to) monitor vBATT and vDIODE to determine if either of these variables changes and indicates that startup is necessary.

If vBATT falls to or below a predetermined threshold minimum voltage, then the controller may be configured to initiate startup of the production of power output 79 by the auxiliary fuel cell stack. This threshold minimum voltage may be predetermined and selected according to a variety of factors, including user preferences, the energy-consuming devices with which the power system will be used, the type of batteries being used, etc. As illustrative non-exclusive examples, threshold values of 5%, 10%, 15%, 20%, or more below the fully charged voltage may be used.

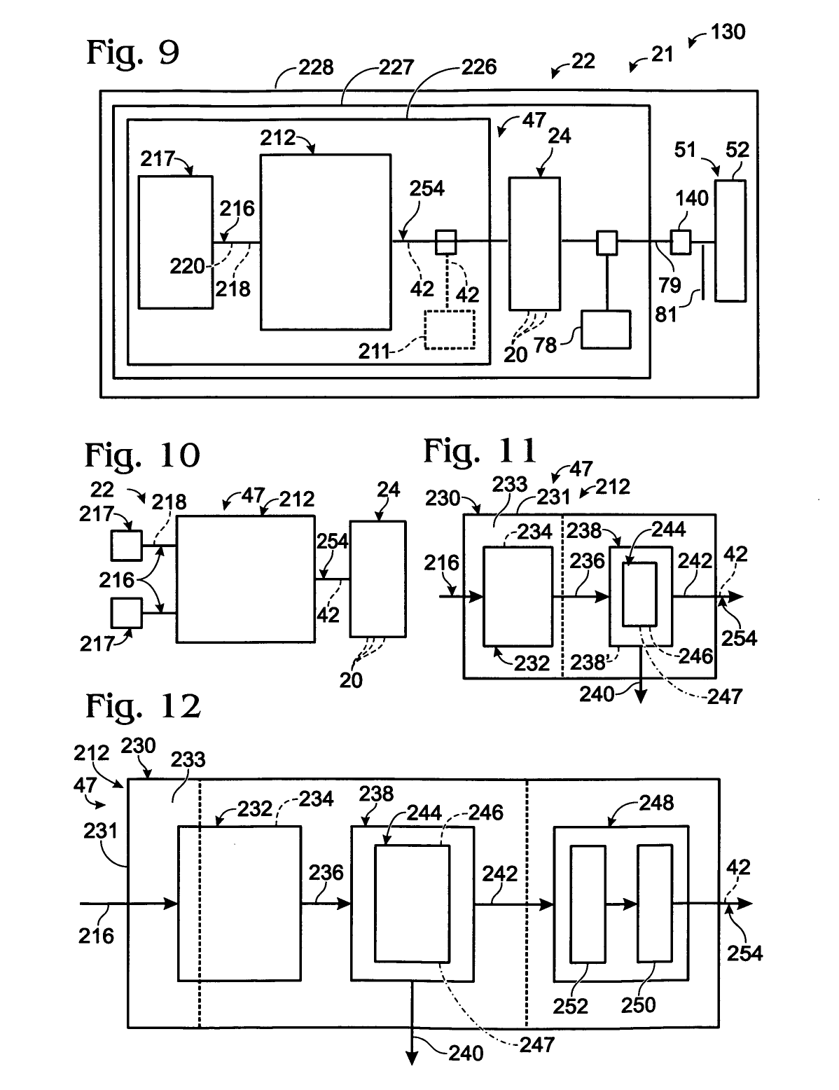

As discussed above, APS 21 includes at least one fuel cell stack 24 that is coupled with a source 47 of hydrogen gas 42 (and related delivery systems and balance of plant components) to form auxiliary fuel cell system 22. Another illustrative, non-exclusive example of such an auxiliary fuel cell system 22 according to the present disclosure is schematically illustrated in FIG. 9. As discussed previously with respect to FIG. 4, examples of sources 47 of hydrogen gas 42 include a storage device 211 that contains a stored supply of hydrogen gas, as indicated in dashed lines in FIG. 9. Examples of suitable storage devices 211 include pressurized tanks and hydride beds. For the purpose of simplifying the structure shown in FIG. 9, controller 142 and its communication linkages are not shown in FIG. 9, although it is within the scope of the present disclosure that they will be present in auxiliary fuel cell systems according to the present disclosure.

An additional or alternative source 47 of hydrogen gas 42 is the product stream from a fuel processor, which produces hydrogen by reacting a feed stream to produce reaction products from which the stream containing hydrogen gas 42 is formed. As shown in solid lines in FIG. 9, system 22 includes at least one fuel processor 212 and at least one fuel cell stack 24. Fuel processor 212 (and its associated feedstock delivery system, heating/cooling assembly, and the like) may be referred to as a hydrogen-generation assembly that includes at least one hydrogen-generating region. Fuel processor 212 is adapted to produce a product hydrogen stream 254 containing hydrogen gas 42 from a feed stream 216 containing at least one feedstock. One or more fuel cell stacks 24 are adapted to produce an electric current from the portion of product hydrogen stream 254 delivered thereto. In the illustrated embodiment, a single fuel processor 212 and a single fuel cell stack 24 are shown; however, it is within the scope of the disclosure that more than one of either or both of these components may be used. These components have been schematically illustrated, and fuel cell systems according to the present disclosure may include additional components that are not specifically illustrated in the figures, such as air delivery systems, heat exchangers, heating assemblies, fluid conduits, and the like. As also shown, hydrogen gas may be delivered to stack 24 from one or more of fuel processor 212 and storage device 211, and hydrogen from the fuel processor may be delivered to one or more of the storage device and stack 24. Some or all of stream 254 may additionally, or alternatively, be delivered, via a suitable conduit, for use in another hydrogen-consuming process, burned for fuel or heat, or stored for later use.

Fuel processor 212 is any suitable device that produces hydrogen gas from the feed stream. Examples of suitable mechanisms for producing hydrogen gas from feed stream 216 include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol. It is within the scope of the present disclosure that the fuel processor may be adapted to produce hydrogen gas by utilizing more than a single mechanism.

Feed stream 216 may be delivered to fuel processor 212 via any suitable mechanism. Although only a single feed stream 216 is shown in FIG. 9, more than one stream 216 may be used and these streams may contain the same or different feedstocks. When carbon-containing feedstock 218 is miscible with water, the feedstock is typically, but not required to be, delivered with the water component of feed stream 216, such as shown in FIG. 9. When the carbon-containing feedstock is immiscible or only slightly miscible with water, these feedstocks are typically delivered to fuel processor 212 in separate streams, such as shown in FIG. 10. In FIGS. 9 and 10, feed stream 216 is shown being delivered to fuel processor 212 by a feedstock delivery system 217.

In many applications, it is desirable for the fuel processor to produce at least substantially pure hydrogen gas. Accordingly, the fuel processor may include one or more hydrogen producing regions that utilize a process that inherently produces sufficiently pure hydrogen gas, or the fuel processor may include suitable purification and/or separation devices that remove impurities from the hydrogen gas produced in the fuel processor. As another example, the fuel processing system or fuel cell system may include purification and/or separation devices downstream from the fuel processor. In the context of a fuel cell system, the fuel processor preferably is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 6,221,117, 5,997,594, 5,861,137, and pending U.S. Patent Application Publication Nos. 2001/0045061, 2003/0192251, and 2003/0223926. The complete disclosures of the above-identified patents and patent applications are hereby incorporated by reference for all purposes.

For purposes of illustration, the following discussion will describe fuel processor 212 as a steam reformer adapted to receive a feed stream 216 containing a carbon-containing feedstock 218 and water 220. However, it is within the scope of the disclosure that fuel processor 212 may take other forms, as discussed above. An example of a suitable steam reformer is shown in FIG. 11 and indicated generally at 230. Reformer 230 includes a reforming, or hydrogen-producing, region 232 that includes a steam reforming catalyst 234. Alternatively, reformer 230 may be an autothermal reformer that includes an autothermal reforming catalyst. In reforming region 232, a reformate stream 236 is produced from the water and carbon-containing feedstock in feed stream 216. The reformate stream typically contains hydrogen gas and other gases. In the context of a fuel processor generally, a mixed gas stream that contains hydrogen gas as its majority component is produced from the feed stream. The mixed gas stream typically includes other gases as well. Illustrative, non-exclusive examples of these other gases, or impurities, include one or more of such illustrative impurities as carbon monoxide, carbon dioxide, water, methane, and unreacted feedstock. The mixed gas, or reformate, stream is delivered to a separation region, or purification region, 238, where the hydrogen gas is purified. In separation region 238, the hydrogen-containing stream is separated into one or more byproduct streams, which are collectively illustrated at 240 and which typically include at least a substantial portion of the other gases, and a hydrogen-rich stream 242, which contains at least substantially pure hydrogen gas. The separation region may utilize any suitable separation process, including a pressure-driven separation process. In FIG. 11, hydrogen-rich stream 242 is shown forming product hydrogen stream 254.

An example of a suitable structure for use in separation region 238 is a membrane module 244, which contains one or more hydrogen-permeable membranes 246. Examples of suitable membrane modules formed from a plurality of hydrogen-selective metal membranes are disclosed in U.S. Pat. No. 6,319,306, the complete disclosure of which is hereby incorporated by reference for all purposes. In the '306 patent, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in the above-incorporated patents and applications, as well as U.S. patent application Ser. Nos. 10/067,275 and 10/027,509, the complete disclosures of which are hereby incorporated by reference in their entirety for all purposes. Membrane(s) 246 may also be integrated directly into the hydrogen-producing region or other portion of fuel processor 212.

The thin, planar, hydrogen-permeable membranes are preferably composed of palladium alloys, most especially palladium with 35 wt % to 45 wt % copper, such as approximately 40 wt % copper. These membranes, which also may be referred to as hydrogen-selective membranes, are typically formed from a thin foil that is approximately 0.001 inches thick. It is within the scope of the present disclosure, however, that the membranes may be formed from hydrogen-selective metals, metal alloys and/or compositions other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen-permeable membrane or membranes may take other configurations as well, such as tubular configurations, which are disclosed in the incorporated patents.

Another example of a suitable pressure-separation process for use in separation region 238 is pressure swing adsorption (PSA), with a pressure swing adsorption assembly being indicated in dash-lot lines at 247 in FIGS. 11 and 12. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 236. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent material. Impurity gases such as NH₃, H₂S, and H₂O adsorb very strongly on the adsorbent material and are therefore removed from stream 236 along with other impurities. If the adsorbent material is going to be regenerated and these impurities are present in stream 236, separation region 238 preferably includes a suitable device that is adapted to remove these impurities prior to delivery of stream 236 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It should be understood, however, that other suitable adsorbent material compositions, forms and configurations may be used.

As discussed, it is also within the scope of the disclosure that at least some of the purification of the hydrogen gas is performed intermediate the fuel processor and the fuel cell stack. Such a construction is schematically illustrated in dashed lines in FIG. 11, in which the separation region 238′ is depicted downstream from the shell 231 of the fuel processor.

Reformer 230 may, but does not necessarily, additionally or alternatively, include a polishing region 248, such as shown in FIG. 12. As shown, polishing region 248 receives hydrogen-rich stream 242 from separation region 238 and further purifies the stream by reducing the concentration of, or removing, selected compositions therein. For example, when stream 242 is intended for use in a fuel cell stack, such as stack 24, compositions that may damage the fuel cell stack, such as carbon monoxide and carbon dioxide, may be removed from the hydrogen-rich stream. The concentration of carbon monoxide should be less than 10 ppm (parts per million). Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, and even more preferably, less than 1%. Especially preferred concentrations are less than 50 ppm. It should be understood that the acceptable maximum concentrations presented herein are illustrative examples, and that concentrations other than those presented herein may be used and are within the scope of the present disclosure. For example, particular users or manufacturers may require minimum or maximum concentration levels or ranges that are different than those identified herein. Similarly, when fuel processor 212 is not used with a fuel cell stack, or when it is used with a fuel cell stack that is more tolerant of these impurities, then the product hydrogen stream may contain larger amounts of these gases.

Region 248 includes any suitable structure for removing or reducing the concentration of the selected compositions in stream 242. For example, when the product stream is intended for use in a PEM fuel cell stack or other device that will be damaged if the stream contains more than determined concentrations of carbon monoxide or carbon dioxide, it may be desirable to include at least one methanation catalyst bed 250. Bed 250 converts carbon monoxide and carbon dioxide into methane and water, both of which will not damage a PEM fuel cell stack. Polishing region 248 may also include another hydrogen-producing device 252, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 800° C., and at pressures in the range of 50 psi and 1000 psi, although temperatures and pressures outside of these ranges are within the scope of the disclosure, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, by the fuel cell system, by an external source, or any combination thereof.

In FIGS. 11 and 12, reformer 230 is shown including a shell 231 in which the above-described components are contained. Shell 231, which also may be referred to as a housing, enables the fuel processor, such as reformer 230, to be moved as a unit. It also protects the components of the fuel processor from damage by providing a protective enclosure and reduces the heating demand of the fuel processor because the components of the fuel processor may be heated as a unit. Shell 231 may, but does not necessarily, include insulating material 233, such as a solid insulating material, blanket insulating material, or an air-filled cavity. It is within the scope of the disclosure, however, that the reformer may be formed without a housing or shell. When reformer 230 includes insulating material 233, the insulating material may be internal the shell, external the shell, or both. When the insulating material is external a shell containing the above-described reforming, separation and/or polishing regions, the fuel processor may further include an outer cover or jacket external the insulation.

It is further within the scope of the disclosure that one or more of the components may either extend beyond the shell or be located external at least shell 231. For example, and as schematically illustrated in FIG. 12, polishing region 248 may be external shell 231 and/or a portion of reforming region 232 may extend beyond the shell. Other examples of fuel processors demonstrating these configurations are illustrated in the incorporated references and discussed in more detail herein.

Although fuel processor 212, feedstock delivery system 217, fuel cell stack 24 and energy-consuming device 52 may all be formed from one or more discrete components, it is also within the scope of the disclosure that two or more of these devices may be integrated, combined or otherwise assembled within an external housing or body. For example, a fuel processor and feedstock delivery system may be combined to provide a hydrogen-producing device with an on-board, or integrated, feedstock delivery system, such as schematically illustrated at 226 in FIG. 9. Similarly, a fuel cell stack may be added to provide an energy-generating device with an integrated feedstock delivery system, such as schematically illustrated at 227 in FIG. 9.

Fuel cell system 22 may (but is not required to) additionally be combined with one or more energy-consuming devices 52 to provide the device with an integrated, or on-board, auxiliary power source. For example, the body of such a device is schematically illustrated in FIG. 9 at 228.

As discussed, it is within the scope of the present disclosure that power supply 154 for the primary power source may take the form of a fuel cell system. In such an embodiment, that fuel cell system may, but is not required to, include any of the components, subcomponents, and variants discussed above with respect to auxiliary fuel cell system 22 and fuel cell stack 24.

### Industrial Applicability

The power and fuel cell systems, controllers and methods of utilizing the same disclosed herein are applicable to the energy-production industries, and more particularly to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An auxiliary power system adapted to provide supplemental power to an energy-consuming assembly normally adapted to be powered by a primary power source, the auxiliary power system comprising:
an auxiliary fuel cell system, comprising:
a fuel cell stack adapted to produce an electrical output from a fuel and an oxidant;
a rechargeable energy-storage device;
a diode electrically positioned between the energy-consuming assembly and the auxiliary fuel cell system, wherein the diode is adapted to be forward biased to permit current flow from the auxiliary fuel cell system and the primary power source to the energy-consuming assembly, while restricting current flow from the primary power source to the auxiliary fuel cell system;
a controller adapted to initiate the production of the electrical output by the auxiliary fuel cell system responsive to at least one triggering event indicative of a demand for the electrical output to be produced by the auxiliary fuel cell system.

2. The system of claim 1, wherein the controller is in communication with the diode and the auxiliary fuel cell system, and further wherein the controller is adapted to regulate at least the operating state of the auxiliary fuel cell system responsive at least in part to at least one of the voltage of the energy-storage device and a relative flow of current from the auxiliary fuel cell system through the diode.

3. The system of claim 2, wherein the controller is adapted to regulate the operating state of the auxiliary fuel cell system responsive at least in part to both of the voltage of the energy-storage device and the relative flow of current from the auxiliary fuel cell system through the diode.

4. The system of claim 1, wherein the controller is adapted to monitor a voltage drop across the diode and to selectively initiate the production of the electrical output by the auxiliary fuel cell system responsive at least in part to the voltage drop across the diode.

5. The system of claim 4, wherein the energy-storage device has a state of charge, wherein the controller is further adapted to monitor the state of charge of the energy-storage device, and further wherein the controller is adapted to selectively initiate the production of the electrical output by the auxiliary fuel cell system responsive to both the voltage drop across the diode and the state of charge of the energy-storage device.

6. The system of claim 1, wherein the triggering event includes a predetermined voltage drop across the diode.

7. The system of claim 1, wherein the triggering event includes the voltage of the energy-storage device of the auxiliary fuel cell system.

8. The system of claim 1, wherein the triggering event includes the state of charge of the energy-storage device of the auxiliary fuel cell system.

9. The system of claim 1, wherein the controller is further adapted to regulate the operation of additional components of the auxiliary power system.

10. The system of claim 1, wherein the auxiliary fuel cell system further includes a charger for the energy-storage device, and further wherein the controller is adapted to initiate the production of current by the fuel cell stack responsive to a detection that the charger is malfunctioning.

11. The system of claim 1, wherein the diode has a fully saturated forward-biased voltage, and further wherein the controller is adapted to automatically initiate the production of current by the fuel cell stack responsive to a detection of a voltage drop across the diode being at least a predetermined percentage of the fully saturated forward-biased voltage drop of the diode.

12. The system of claim 1, wherein the controller is adapted to detect a voltage of the energy-storage device, and further wherein the controller is adapted to automatically initiate the production of current by the fuel cell stack responsive to a detection that the voltage of the energy-storage device is at or below a predetermined minimum voltage.

13. The system of claim 1, wherein the energy-storage device includes at least one battery.

14. The system of claim 1, wherein the energy-storage device includes at least one of a capacitor and an ultracapacitor.

15. The system of claim 1, wherein the energy-storage device is adapted to store at least a portion of the current produced by the fuel cell stack.

16. The system of claim 1, wherein the energy-storage device is adapted to be selectively recharged by the fuel cell stack.

17. The system of claim 1, wherein the energy-storage device is adapted to be selectively recharged by the primary power source.

18. The system of claim 1, wherein the energy-storage device is adapted to be selectively recharged by a power source other than the fuel cell stack.

19. The system of claim 1, wherein the energy-storage device is sized to have sufficient capacity to satisfy the entirety of an expected applied load from the energy-consuming assembly for at least a sufficient period of time for the auxiliary power system to transition from an operating state in which the fuel cell stack is not producing an electrical output to a power-producing operating state, in which the fuel cell stack is producing an electrical output sufficient to satisfy an applied load from the energy-consuming assembly.

20. The system of claim 1, wherein the auxiliary power system is adapted to provide an electrical output having a lower voltage than the voltage of the electrical output that the primary power source is configured to provide to the energy-consuming assembly.

21. The system of claim 20, wherein the auxiliary power system is adapted to provide an electrical output having a voltage that is less than the voltage of the electrical output that the primary power source is designed to provide.

22. The system of claim 1, wherein the auxiliary power system is configured to produce an electrical output that has a voltage that is at least 1 volt lower than the voltage of the electrical output that the primary power source is configured to provide.

23. The system of claim 1, wherein the auxiliary power system is adapted to provide an uninterrupted supply of electrical output to the energy-consuming assembly when the primary power source ceases to supply a sufficient electrical output for the energy-consuming assembly.

24. In an energy-producing system that is adapted to provide an electrical output to satisfy an applied load from an energy-consuming assembly and which includes a primary power source that is normally adapted to provide an electrical output to satisfy the applied load and an auxiliary power system that is adapted to provide an electrical output to satisfy the applied load when the primary power source is not available to satisfy the applied load and which includes an auxiliary fuel cell system that comprises at least a fuel cell stack that is adapted to produce an electrical output and an energy storage device, a method for initiating startup of the auxiliary fuel cell system, the method comprising:
monitoring a state of charge of a battery assembly associated with the auxiliary fuel cell system; and
initiating delivery of fuel and oxidant to the fuel cell stack responsive to the state of charge of the battery assembly falling below a predetermined threshold.

25. The method of claim 24, wherein the method further includes monitoring a voltage of a diode that is electrically positioned between the auxiliary fuel cell system and at least one of the primary power source and the energy-consuming assembly, and further wherein the method comprises initiating delivery of fuel and oxidant to the fuel cell stack responsive to detection of the voltage of the diode exceeding a predetermined forward-bias voltage of the diode.

26. In an energy-producing system that is adapted to provide an electrical output to satisfy an applied load from an energy-consuming assembly and which includes a primary power source that is normally adapted to provide an electrical output to satisfy the applied load and an auxiliary power system that is adapted to provide an electrical output to satisfy the applied load when the primary power source is not available to satisfy the applied load and which includes a fuel cell stack that is adapted to produce an electrical output, a battery assembly, and a diode electrically positioned between the an auxiliary fuel cell system and at least one of the energy-consuming assembly and the primary power source, a method for initiating startup of the auxiliary fuel cell system, the method comprising:
monitoring voltage across the diode; and
initiating delivery of fuel and oxidant to the fuel cell stack responsive to the monitored voltage across the diode exceeding a predetermined threshold voltage.

27. The method of claim 26, wherein the predetermined threshold voltage corresponds to a fully saturated forward-biased voltage drop across the diode.

28. The method of claim 27, wherein the method further includes monitoring the voltage of the battery assembly, and further wherein the method includes initiating delivery of fuel and oxidant to the fuel cell stack responsive to at least one of the voltage across the diode exceeding a predetermined threshold voltage and the voltage of the voltage of the battery assembly falling to or below a predetermined minimum voltage.

29. The method of claim 28, wherein the method includes initiating delivery of fuel and oxidant to the fuel cell stack responsive to both of the voltage across the diode exceeding a predetermined threshold voltage and the voltage of the battery assembly falling to or below a predetermined minimum voltage.
